(19) United States
(12) Patent Application Publication
(10) Pub. No.: US 2016/0131382 A1
(43) Pub. Date: May 12, 2016

(54) METHOD AND APPARATUS OF NETWORKED THERMOSTATS PROVIDING FOR REDUCED PEAK POWER DEMAND

(71) Applicant: Howard Rosen, Montreal (CA)

(72) Inventor: Howard Rosen, Montreal (CA)

(21) Appl. No.: 14/539,145

(22) Filed: Nov. 12, 2014

(51) Int. Cl. F24F 11/00; G05B 15/02; F24F 11/02

(52) U.S. Cl. CPC F24F 11/006; F24F 11/0012; F24F 11/0034; F24F 11/02; G05B 15/02; F24F 2011/0047; F24F 2011/0063; F24F 2011/0071; F24F 2011/0075

(57) ABSTRACT

An improvement in operation of a network of thermostats is disclosed which reduces peak power demand requirements for a facility that utilizes a plurality of heating, ventilation and cooling systems controlled by the thermostats or by a central control system utilizing status data from a plurality of thermostats.

### FIELD OF USE

This invention relates to the art of environmental control systems, to thermostats which control heating, ventilation and cooling systems, and in particular to thermostats which are connected in a network to other thermostats or to a central control system.

Further optional aspects of the invention relate to thermostats which include occupancy sensors or motion sensors for detecting occupancy within a conditioned space and optionally including detecting and/or recording patterns of occupancy within a conditioned space.

### BACKGROUND OF THE INVENTION

Occupancy detection and/or patterns of occupancy are optionally utilized by certain thermostats to reduce overall electrical power consumption in the heating, cooling, or ventilation of a room or conditioned space. When a plurality of thermostats are used to control a corresponding plurality of Heating, Cooling, and/or Ventilation Systems (HVAC Systems) it may happen that turning on a number of HVAC systems results at the same time or over a short period of time may result in a high “peak demand” in usage of electrical power.

High peak power demands are often deemed as detrimental by power companies supplying power to an end user and there are often charges associated with high peak power demand. Some power companies charge a peak demand fee where peak demand is defined as peak power consumption during a measured period of time within a billing cycle. As an example, peak power demand can be defined by the power company as the maximum load utilized by a customer for any fifteen minute period within a one month billing cycle. Another power company may define this for a one hour period within a one week or one month period. In general, peak demand is defined for some fairly short period of time such as 15 minutes to an hour for a period of time that is typically one month. Some power companies choose to measure peak demand only during certain periods of the day such as between 9:00 a.m. and 9:00 p.m. and charging for peak demand only on weekdays Monday through Friday.

The customer cost of peak power demand can be applied in various ways such as, for example, a multiplier on the overall power usage based on peak power demand. Another exemplary alternative is to apply a peak power demand multiplier on a fixed base monthly rate demand charge which is then added to a customer's bill. Each power company is free to decide its own algorithms for peak power demand charges. In general, demand based charges or demand based rate structures are designed to discourage customers from using a very high amount of electrical power at one time in comparison to the average power used over a longer period of time, and in particular to reduce peak power demand during high usage periods of a typical day.

### BRIEF SUMMARY OF THE INVENTION

It would be therefore be an improvement in overall energy cost of operation of a plurality of HVAC systems controlled by a plurality of networked thermostats if peak power demand of the plurality of HVAC systems can be reduced.

It would be a further advantage in control of the HVAC systems to base the HVAC control on the specific rules for measuring peak power demand specified by the power company serving power to those HVAC systems. It would be a further advantage to base the thermostat control upon location of the thermostat including optionally user input features for providing or detecting an HVAC location, for example by zip-code or GPS coordinates, or for determining automatically a location based upon, for example, the thermostat's connection to a network such as a local Wi-Fi network, or by utilizing GPS coordinates obtained from a local or controlling cell phone or personal mobile device connected to the thermostat. Other options for determining/detecting HVAC location information in order to determine a power company and its demand rate structure could be readily devised by one knowledgeable in the state of the art of the design of computers, thermostats, and/or personal mobile devices. It is a further advantage for power companies that have more than one demand rate structure, or for which the demand rate algorithms change based on seasons or dates within a year to allow a user to select which demand rate structure is to be applied. A further advantage is to provide for automated communication with a central server which stores a description of demand rate structures and characteristics for a plurality of power companies and further to optionally enable the user to assist in making a specific selection from those descriptions.

Another optional improvement in overall cost of operation is to have each thermostat detect for conditions of occupancy within its own conditioned space and then use the results in controlling peak power demand of a plurality of HVAC systems. A further optional enhancement is to utilize patterns of occupancy and/or historical patterns of occupancy in overall control of the plurality of HVAC systems. For example, if a thermostat “knows” based on patterns of occupancy that its related conditioned space is almost always going to become occupied in the next fifteen minutes, then that thermostat can be given priority in immediate use of power in comparison to a thermostat that “knows” its conditioned space is never or almost never occupied in the next upcoming hour.

According to another illustrated embodiment of the present invention, a network of thermostats provides for communication between the thermostats such that each thermostat utilizes information from other thermostats to determine whether or not its own HVAC system should be turned on or off to limit or control total overall peak power consumed by the plurality of HVAC systems.

In another illustrated embodiment of the present invention, a plurality of thermostats are connected to each other and operate to collectively determine which HVAC systems should be turned on based upon one or more factors such as: a) current state of occupancy from each thermostat, b) patterns of occupancy from each thermostat or collectively from a plurality of thermostats, c) current total estimated overall power consumption, d) time of day, e) billing period, f) current day within billing period, g) past peak power usage within current billing period, h) comparison of each thermostat's current set-point to measured temperature in its conditioned space, i) total number of HVAC systems presently turned on, j) past billing cycle(s) peak demand, k) period of time that power to a specific HVAC system has been denied, and l) a description of the peak demand definition as defined by the power utility and accessed from a table based on location based data such as a zip-code or based upon input from a user of the thermostat.

In another illustrated embodiment of the present invention, a plurality of thermostats are connected to a central controller and the central controller in conjunction with the plurality of thermostats determines which HVAC systems should be turned on based upon one or at least a selected number of factors such as: a) current state of occupancy from each thermostat, b) patterns of occupancy from each thermostat or collectively from a plurality of thermostats, c) current total estimated overall power consumption, d) time of day, e) billing period, f) current day within billing period, g) past peak power usage within current billing period, h) comparison of each thermostat's current set-point to measured temperature in its conditioned space, i) total number of HVAC systems presently turned on, j) past billing cycle(s) peak demand, k) period of time that power to a specific HVAC system has been denied, and l) description of the peak demand definition as defined by the power utility and optionally accessed from a table based optionally on location based data such as a zip-code or based upon input from a user of the thermostat.

In another illustrated embodiment of the present invention, a thermostat receives a description of peak power demand rate structure that is applicable for the power company supplying power to its connected HVAC system. The thermostat receives this description from user input, user selection from a menu, or other ways that could be devised by one knowledgeable in the art of thermostat design. The thermostat then sends information describing the applicable peak power demand rate to other thermostats. The plurality of thermostats then use that information to collectively cooperate in reducing peak power demand charges, either in the current time period, or over a period of time either predefined, or defined by user input, or based on the peak power demand rate structure.

In another illustrated embodiment of the present invention, a thermostat stores or utilizes a “previous” peak demand indicator and attempts to keep current peak demand below the previous peak demand. The reasoning behind this, for example, is that a power company typically charges on a monthly time period and invokes a “penalty demand” charge on that user based on the highest peak demand during the month. When a month ends, the calculation starts over. With a clean slate at the start of a billing period, a plurality of thermostats communicates with each other in order to try to minimize peak demand. On the first day the peak demand for that first day is logged, and on the second day the thermostat attempts to keep peak demand below that amount. There is no or reduced need to limit current demand if the current demand is less than the peak demand figure already established within the current measurement period. If on the second day a higher peak demand is necessary to achieve adequate comfort levels, then that higher peak demand becomes the new limit on demand for the following days or until it is necessary to exceed that and a new higher limit is established. The requirement for current demand compared to previous peak demand is balanced by an estimate of “comfort” that must be maintained so that occupants of the room are satisfied. In further enhancement to this aspect of comfort, occupancy sensors operatively coupled to each thermostat allow for those areas which are currently occupied to be first satisfied in their need for power compared to those HVACs serving unoccupied areas. Also as previously mentioned, patterns of occupancy are readily incorporated into a methodology to be used for determining which HVAC gets higher priority to power in comparison to others.

This description is exemplary and the period of time for minimizing and logging previous peak demand would not have to be a day; it could be any period of time, or even just the highest peak demand previously used without regard to days, which may be found dependent upon a specific implementation to be the most advantageous and straight-forward solution.

In another embodiment of the present invention, a thermostat provides or includes the capability of providing utilizing a user input apparatus and/or a mechanism that provides for a user to describe a peak power demand rate structure that is applicable for that thermostat as served by the local power company. The input apparatus or mechanism provides for a plurality of these exemplary typical elements that make up a demand rate structure: for example, a) description of the period of time utilized in determining a peak demand figure, b) description of a billing cycle, c) description of peak demand rate multiplier or other cost factors associated with peak demand rate structure, d) description of periods of time with different rate structures for each day, week or dependent on holidays. The user may also optionally specify an absolute peak demand limit.

In another embodiment of the present invention, locally connected thermostats which cooperate to minimize peak power demand charges will also benefit from information describing current or predicted usage of power not under direct control by the thermostats. That is, for example, usage by hot water heaters, washers, dryers, ovens and other major use appliances. Even more benefit is achieved by having connection for monitoring current power usage at the power entry point for the facility (where the meter is). Some electric meters provide indication of current measured power usage that is available externally to the meter, and also to peak demand previously measured. Operative coupling between an electrical power meter measuring power to the facility of the HVAC systems and one or more of a plurality of networked thermostats local to a single property may provide for better control of peak power demand and thus can result in reduced peak power demand charges.

In another embodiment of the present invention a plurality of thermostats are sent commands or the thermostats work in coordination with time periods determined during which operation of the thermostat's HVAC system is not allowed or not “recommended” unless higher than normal “need” is identified. The time periods are defined for each thermostat in a manner such that thermostats have different time periods for operation and the number of HVAC systems in operation at any one period of time is thus limited. The calculation and determination of time periods can be performed by the thermostats themselves, or by a central server. A random number based distribution of time periods can also be utilized. For example, if the power demand rate structure incorporates time periods of fifteen minutes for measurement of peak demand, then a plurality of thermostats are set such that no more than half of the thermostats turn on their HVAC systems in any one fifteen minute period. This would reduce peak demand by one-half compared to a chance, without the invention, that all thermostats might turn on their associated HVAC systems for one fifteen minute period. In another similar approach thermostats are assigned fairly short time slots for running and coordinated such that during one period of time no more than “N” HVAC systems are turned on. For example during a fifteen minute period any HVAC system could run for no more than five minutes, which would potentially reduce the highest possible peak demand by one-third. The time based approach is further enhanced by including time of day in determining the setting of the “allowed to run” time periods for the plurality of thermostats.

In another embodiment of the present invention anticipation of need is made a part of the peak demand control determination such that during periods when current demand is below a previously used peak then HVAC systems can be turned on in anticipation of need. For example, knowing that a peak of six HVAC units turned on has been previously recorded within the current billing cycle, and knowing that a hot afternoon is on the nearby horizon, then set-point temperatures for a period of time prior to the hottest period of the afternoon are lowered and the conditioned spaces are thus pre-cooled in anticipation of the hottest part of the day in order to reduce the potential peak demand.

It is noted that as an optional improvement in determining from priority of “need” based upon measurements by a plurality of thermostats in a corresponding set of conditioned spaces and controlling a corresponding plurality of HVAC systems that a mechanism or methodology can be defined that “considers” (factors in) such elements as: a plurality of measurements of temperature from the thermostats, the user settings of each thermostat, the time of day, the state of occupancy as detected by the thermostats, the patterns of occupancy recorded or previously noted by the thermostats, etc. Many factors are optionally used in determining a level of “need” for a particular conditioned space in comparison to the level of “need” in other conditioned spaces. An exemplary method for determining a “level of need” value for a plurality of conditioned spaces is to combine several factors using weighting applied to each factor to determine an overall need, the need for each conditioned space then compared to calculated need for other spaces in order to determine which HVAC systems should be turned on in order to best optimize use of power.

A level of need factor is a factor in one method to be used to determine when the previous peak power usage is not enough to meet current demand for power without going beyond previously established limits on how much “discomfort” (as described by a level of need value) can be tolerated.

Some examples of such needs are now described.

The type of use of a conditioned area is an optional consideration in determining level of need. For example, hallways might be deemed less important than meeting rooms and therefore would be factored in with lower “need” in a needs evaluation equation. Similarly, meeting rooms with many potential occupants might be deemed more important than an open area with typically few people in that open area. In general, the number of potential or current occupants could be used to raise overall the overall level of need estimated for that conditioned space.

“Need” weighting for particular areas can be set by facilities personnel where either groups of rooms or spaces, or individual rooms or spaces are assigned need weighting factors. For example, a Very Important Person room or group of rooms could be assigned a higher “need” weighting so that those rooms are served first by HVAC units when demand is near previous peak usage. Or, certain groups of rooms or individual rooms or spaces might be temporarily or permanently set to ignore need based operation. This can be done even though power drawn by the associated HVAC units is considered in maintaining control overall peak power usage.

Exposure of rooms or spaces to sunlight or other environmental conditions is also a potential consideration in determining “need”. For example, rooms which are exposed directly to afternoon sun may need more cooling when first occupied than rooms with less exposure.

Need can also be weighted based upon the price paid for a room.

Time of day is also important in controlling peak power usage. For example, if the time of day is nearing the end of a peak power measurement period then it may be advantageous to delay high power usage for a short time until after the time where the power company is measuring peak power demand.

Need weighting can be lowered in response to occupant request either voluntarily or as an incentive for lower charges.

It is also advantageous to consider current thermostat settings in comparison to previously established “standard” settings. For example, say a person in room “A” sets his thermostat to 60 degrees Fahrenheit for cooling, and the current room temperature is 70 degrees, then the need differential temperature is 10 degrees which is quite high. Another person in room “B” sets his thermostat to 74 degrees and the current temperature of that room is 78 degrees, thus the need differential temperature is 4 degrees which is reasonably low. But, it is likely to be better in terms of overall comfort to give space “B” a higher “need” than space “B” and to not reward the people in room “A” for setting their thermostat far lower than what is reasonably necessary. It is advantageous to consider “need” with respect to previously established reasonable set-point temperature settings rather than comparison between just the set point and the current temperature.

As an example of level of need calculations and determination of need priority consider NN thermostats in NN motel rooms with N of the NN thermostats determining current “need” for air conditioning (that is the measured temperature is above the current set-point for that thermostat). Highest priority can be given to the room that is 1) occupied, and 2) with measured current temperature that is at highest deviation from thermostat's current set-point temperature. These thermostats are “satisfied” first until there are none that fit this description. Second highest priority is then given in the same manner to the needs of rooms that are expected, based upon analysis of past patterns of occupancy, to be soon occupied. (“Soon” meaning for example in the next half-hour). Third highest priority is given to unoccupied rooms. Estimated current peak power is tracked as these “needs” are evaluated and power is limited when the current power is near to that used in an already established peak usage of power in the current billing cycle (peak power “billing” time period as dependent on the power company, typically one month).

It should also be noted that peak power demand rates are not typically based upon “instantaneous” peak power. Instead power usage peak determination is based upon power used during a fairly short period of time such as fifteen minutes, or half an hour. When power is being allocated to the HVAC systems it is okay for an instantaneous peak of power to be utilized for a period of time smaller than the peak measurement period as long as the total power consumed in the current measurement period is less than the previously established peak usage. It is also noted that power companies typically define the peak power determination period as being any continuous period of time. That is, for example, a fifteen minute peak measurement period means any fifteen adjacent minutes.

In another embodiment of the present invention, various factors such as measured temperature, comparison of measured temperature to set-point temperatures and other such elements as those previously discussed can be prioritized with a methodology or apparatus that “weights” various factors and then forms a “goodness” measurement based upon a weighted sum of all the factors and elements. Such methodology can be readily devised by one knowledgeable in the art of electronic and/or thermostat design.

It is further noted that controlling peak power usage can be done based upon static restriction, adaptive restriction or a combination of static and adaptive restriction. For example, an absolute peak power usage setting could be applied that prevents, for example, more than XX percentage of the HVAC units from being turned on at any one time. This would be a static and absolute restriction. An alternative exemplary approach would be to not allow more than XX percentage of the HVAC units to be turned on at one time within a defined period of time. This would also be a static restriction. An exemplary adaptive approach allows for YY HVAC units to be turned on where the number YY is a previously established peak usage number, and then determining if YY should be exceeded based upon a weighted analysis of “need” to develop a level of need value. An absolute limit on percentage of units turned on once YY has been exceeded can also optionally be applied, with this be a combination of adaptive and static settings and methods.

In communicating between thermostats and/or with a central system/controller the thermostats can provide several possible items of information for peak power control that are elements that optionally factor into determination of how many and which ones of the plurality of HVAC systems should be turned. These include, for example: a) the current set-points of each thermostat in comparison to the current measured temperature, b) the current measured temperature compared to a pre-set temperature (such as 74 degrees F.), c) current occupancy status of the space in which each thermostat is located, d) predicted near-term occupancy of the space in which each thermostat is located based upon patterns of occupancy for either specific rooms or for a plurality of rooms or for the overall facility, e) the time of day, f) the day of the week, g) the season, h) the outdoor temperature, i) the current weather or predicted weather or predicted outdoor temperature, j) user program settings for each thermostat, k) time since user last changed settings or specific selected settings of each thermostat, l) number of occupants estimated to be in each room based upon activity levels indicated by occupancy sensor, m) the “importance” of people in each room (Very Important Person status), and m) other similar or related such factors as could be determined by one skilled in the art of thermostat and/or HVAC system design.

It is a further advantage in practice of the present invention to utilize more accurate measurements or indication of power usage than what is directly known only from thermostat data. An example of this enhancement is an indication from the power company of peak power usage in the current billing cycle, and indication of actual current power usage. This type of information typically provides more accurate data describing both past and current usage of power within a facility. For example, a plurality of thermostats by themselves would not “know” anything about power usage outside control of the thermostats, such as usage by washing and drying equipment or lighting equipment. By providing a better measurement of past peak power usage and current actual power usage as is typically available in from many “smart” power meters, better control of costs and power usage can be accomplished by practice of the invention with a thermostat network or a thermostat network integrated with a centralized server as exemplified in previously described embodiments of the present invention. Information such as this may be available over a network connection from the power company, or more directly from a local power meter measuring power to the facility.

More specifically an exemplary embodiment of the present invention includes an operative coupling between a power measurement apparatus, such as a smart power meter, to the thermostat network and/or an optional central server. The power measurement apparatus provides information indicative of current measured power usage, and optionally provides further information indicative of past measured peak power usage. This has some advantage over other possible implementations because measurement by a power meter of actual usage is more accurate and possibly much simpler since the power meter may already have incorporated into its own measurement apparatus information describing the rate structure and/or the peak demand measurement period as set by the power company. Thus, this information would not have to be provided in another manner to the thermostat or by a user of the thermostat or thermostat network.

In a further enhancement to the present invention it is advantageous to control power to each HVAC system for “conditioning” (heating or cooling) separately from power for the air circulation fan of that HVAC system. Most HVAC systems provide for turning on an “indoor” fan motor even though the HVAC system is not being instructed to condition the air. When a room or space is being denied conditioning of its air because of high power demands for other areas (in order to limit peak power demand) then it is an option to turn on just the fan in those areas. Especially in cooling mode, having a fan blowing may help keep people comfortable even though the room temperature is somewhat higher than the current set-point temperature. Thus it would be an optional enhancement to the present invention to turn on the fan whenever power usage is being denied and the associated unit is in “cooling” mode, or is presented with need for cooling.

Determination of a methodology or algorithm for establishing “need” for air conditioning (heating or cooling) and prioritization of need can be approached in many ways that could be determined by one knowledgeable in the art of thermostat design, electronic circuit design, or with other technical background. One exemplary approach is to form a “need” value for each conditioned space, sort the need values, and then when current power usage exceeds or approaches a previously established peak usage for the current billing/peak measurement period, then limit usage by those HVAC systems conditioning air for the conditioned spaces with the lowest “need” value(s). A level of need value can be formed, for example, with a calculation for each conditioned space “N” as shown in the following exemplary equation:

IF ( CoolingMode(N) ) {

IF ( CurrentTemperature(N) <= SetPointTemperature(N) )

{ NEED(N) = 0; }

ELSE

{ NEED(N) = VIPWeighting(N) *

( ( CurrentTemperature(N) − 72 ) * 4 )
+ (CurrentTemperature(N) − SetPointTemperature(N)) * 1

)

}
ELSEIF ( HeatingMode(N) {

IF ( CurrentTemperature(N) >= SetPointTemperature(N) )

{ NEED(N) = 0; }

ELSE

{ NEED(N) = VIPWeighting(N) *

( (72 − CurrentTemperature(N) )) * 4 )
+ (SetPointTemperature(N) −CurrentTemperature (N)) * 1

)

}
ELSE{ NEED(N) = 0 };

In the above equation “N” represents one of N thermostats each controlling its own HVAC system with the N HVAC systems conditioning air for N conditioned spaces. A higher NEED for a specific conditioned space means that conditioning for that space is to be a considered a higher priority than for a space with a lower NEED. In operation, HVAC systems for spaces with lower NEED values are turned off when current peak power demand is higher than a previously established peak power usage value. If the value of NEED for a particular space exceeds some pre-established minimum comfort level need value then it will NOT be turned off, and if too many of the spaces are in this “heightened” condition of NEED then it may cause the current power usage to exceed the previously established peak power usage value and so the previously established peak power usage value would then be set to the current usage (or estimated usage).

### BRIEF DESCRIPTION OF THE SEVERAL VIEWS OF THE DRAWING

The invention is better understood by reading the detailed description of the invention in conjunction with the accompanying drawings in which:

FIG. 1 is an illustration of an exemplary thermostat incorporating features of the present invention, the thermostat connected to other exemplary similar or identical thermostats also incorporating features of the present invention;

FIG. 2 is an illustration of another embodiment incorporating some features of the present invention with FIG. 2 being similar to FIG. 1 except that it illustrates a plurality of thermostats which are connected to a central server utilizing a network connection apparatus;

FIG. 3 is one exemplary illustrated embodiment incorporating features of the present invention an illustration of Networked Thermostats which receive peak power usage and/or rate data from an external source such as a power meter for the facility, the data received describes various things relating to peak power usage; and

FIG. 4 is an illustration of a simple exemplary method for managing peak power usage for a facility including a plurality of thermostats and HVAC systems conditioning air for a plurality of conditioned spaces.

### DETAILED DESCRIPTION OF THE INVENTION

The following detailed description includes references to the accompanying figures of the drawing, which form a part of the detailed description. The figures show, by way of illustration, specific embodiments in which the apparatus may be practiced. These embodiments, which are also referred to herein as “examples” or “options,” are described in enough detail to enable those skilled in the art to practice the illustrated embodiments. The disclosed embodiments may be combined, other embodiments may be utilized or structural or logical changes may be made without departing from the scope of the invention. The following detailed description is, therefore, not to be taken in a limiting sense and the scope of the invention is defined by the appended claims and their legal equivalents.

The present invention as described and/or illustrated according to the embodiments discussed above is directed to an improved method and system for managing a network of thermostats that overcomes the limitations of traditional approaches.

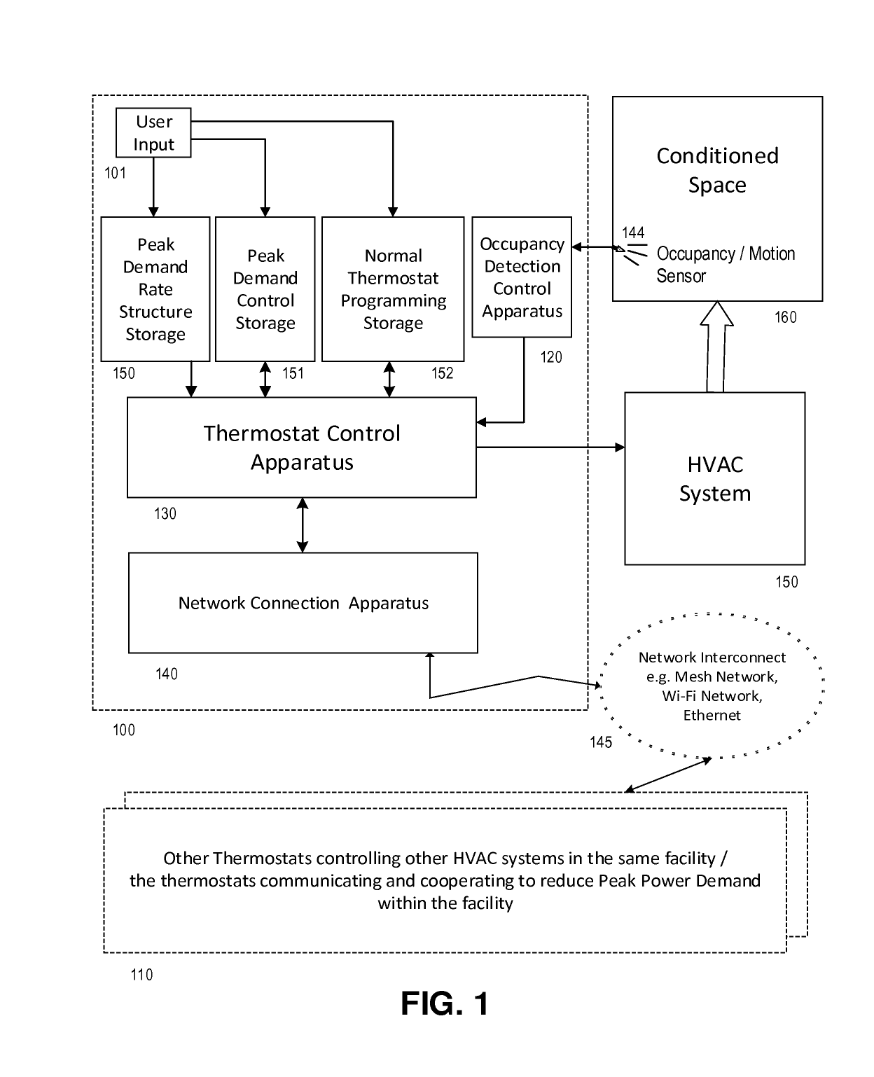

FIG. 1 provides illustration of an exemplary thermostat 100 incorporating features of the present invention, the thermostat connected to other exemplary similar or identical thermostats 110 also incorporating features of the present invention. The thermostat 100 provides for user input 101, the user input for providing settings and/or parameters for utilization by the overall plurality of thermostats in controlling power usage of related HVAC systems controlled by the overall plurality of thermostats so as to limit peak power usage charges relating to the power usage of the related HVAC systems. In the figure one particular HVAC system 150 is illustrated providing conditioned air to a conditioned space 160. The conditioned space has an optional occupancy/motion detection sensor 144 located within the conditioned space 160. The occupancy/motion sensor is connected to thermostat's 100 occupancy detection and control apparatus 120 so as to provide to the thermostat control apparatus 130 an indication as to an occupancy status for the conditioned space, or optionally further to provide an indication not only of occupancy but also an indication of level of activity within the conditioned space. The occupancy sensor 144 may also be optionally incorporated into the housing of the thermostat with the thermostat mounted in the conditioned space. The thermostat apparatus itself may also not necessarily be located in the conditioned space as long as it is provided capability for measuring temperature within the conditioned space. The thermostat further includes apparatus for storing parameters 150 describing a peak demand rate structure which is used by the thermostat control apparatus in determining items of information relating to the peak demand rate structure such as when peak demand rates are in effect, the period of time required to establish a peak usage measurement, the billing period, and other similar items of information relating to peak demand charges. Other items of information such as the peak power demand previously utilized within the current billing period are also useful in controlling peak power usage. The thermostat apparatus also may include control program storage 151 that controls a microprocessor based apparatus incorporating one or more features of the present invention, and that control program storage may be either a part of normal thermostat programming storage 152 as in typical microprogram/microprocessor implementation of modern thermostats, or separate. In a general manner the storage apparatus is utilized by an overall thermostat control apparatus 130 so as to control usage of power by the HVAC system 150, working in concert with other thermostats 110 to minimize charges by a power company supplying power to the HVAC systems, and especially charges relating to peak power demand. The thermostats may optionally communicate using a network connection apparatus 140 to connect to a network 145 connecting the overall plurality of thermostats, or in another alternative exemplary implementation of the present invention the connections to other thermostats are hardwired. It is noted that the network interconnect may be a wireless network (Wi-Fi network), a hardwired Ethernet connection to Ethernet bridges or switches or routers or other networking schemes well known in the art. It is further noted that user input in this figure is exemplary and may be implemented in many ways by one skilled in the art of electronic system design or other similar fields of expertise. For example user input can be implemented with input coming from an input apparatus incorporated into one or more of the thermostats, or user input may come from a central server providing a programming interface, or in other ways as may be devised by one skilled in the art of electronic system design or other similar fields of expertise.

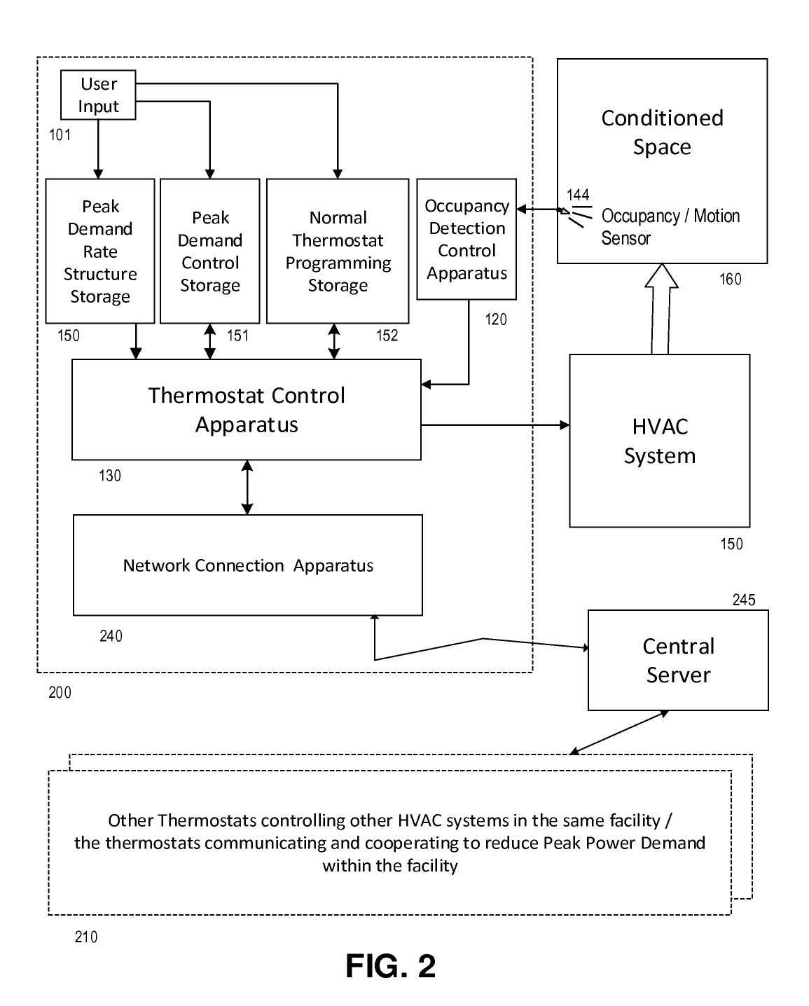

FIG. 2 provides illustration of another embodiment incorporating some features of the present invention with FIG. 2 being similar to FIG. 1 except that it illustrates a plurality of thermostats 200 and 210 which are connected to a central server 245 utilizing a network connection apparatus 240. The central server in this illustrated embodiment may provide for communication between the thermostats or it may provide for a central location for collection of information and optionally for sending control commands to the thermostats for limiting or optimizing power usage so as in an overall manner to minimize peak power demand charges by a power company. The network connection apparatus 240 may be implemented to communicate with networks of many types as well known in the art and the thermostats may include, for example, connection to a mesh network with nodes that are the thermostats themselves with the central server also optionally being a node in the mesh network or connected by other means to the mesh network.

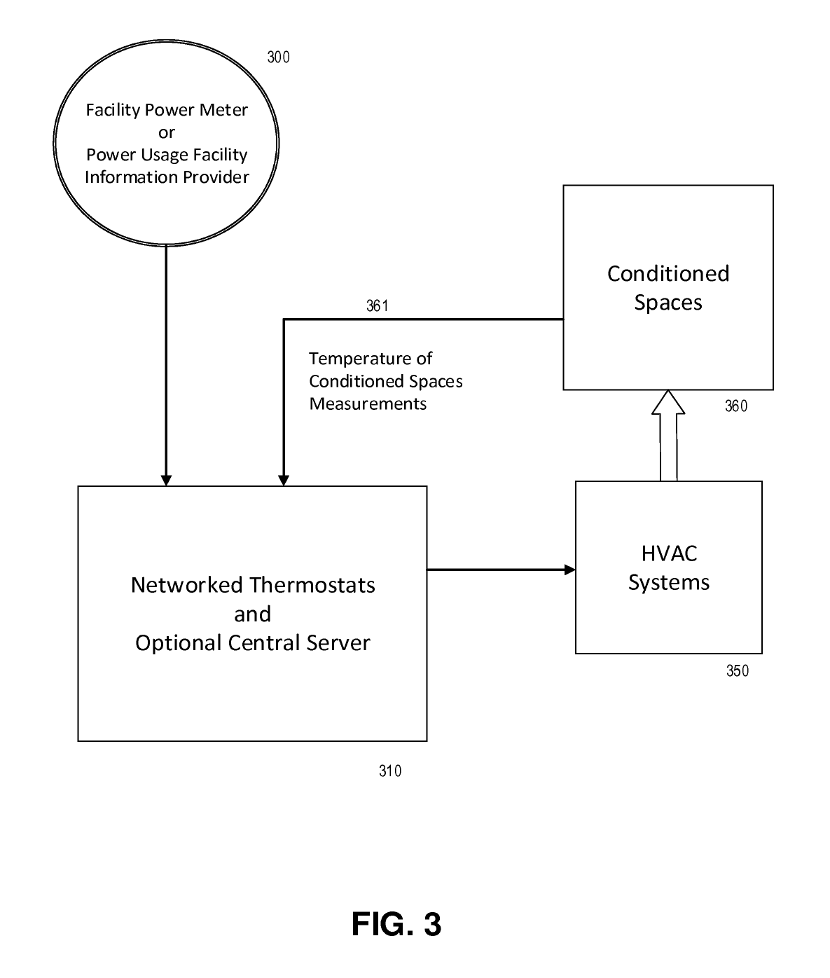

FIG. 3 provides as one exemplary illustrated embodiment incorporating features of the present invention an illustration of Networked Thermostats 310 which receive peak power usage and/or rate data from an external source such as a power meter for the facility 300, the data received describes various things relating to peak power usage. For example, the Networked Thermostats can be provided with a signal as to when peak power usage is being measured. Another example is to provide the networked thermostats (or central server) with data describing the times of day and/or days of week that peak power usage is being measured. Another example is to provide the time period or other similar characteristics that describe the methodology for determining and charging for peak power usage. Another example of useful data is to provide an indication of total current power currently being used. Another example is to provide the previous peak power usage measured within the current billing period. Another example is to provide description of the billing period relating to peak power usage measurements. The networked thermostats and optional central server 310 utilize the data/information from the facility power meter or power usage facility information provider 300 in control a plurality of HVAC systems 350 so as to minimize or reduce peak power usage and/or to reduce peak power demand charges invoked by the power company serving power to these HVAC systems. The Networked thermostats 310 are also provided with normal data such as current temperature measurements 361 of the conditioned spaces 360 that are being conditioned by HVAC systems 350.

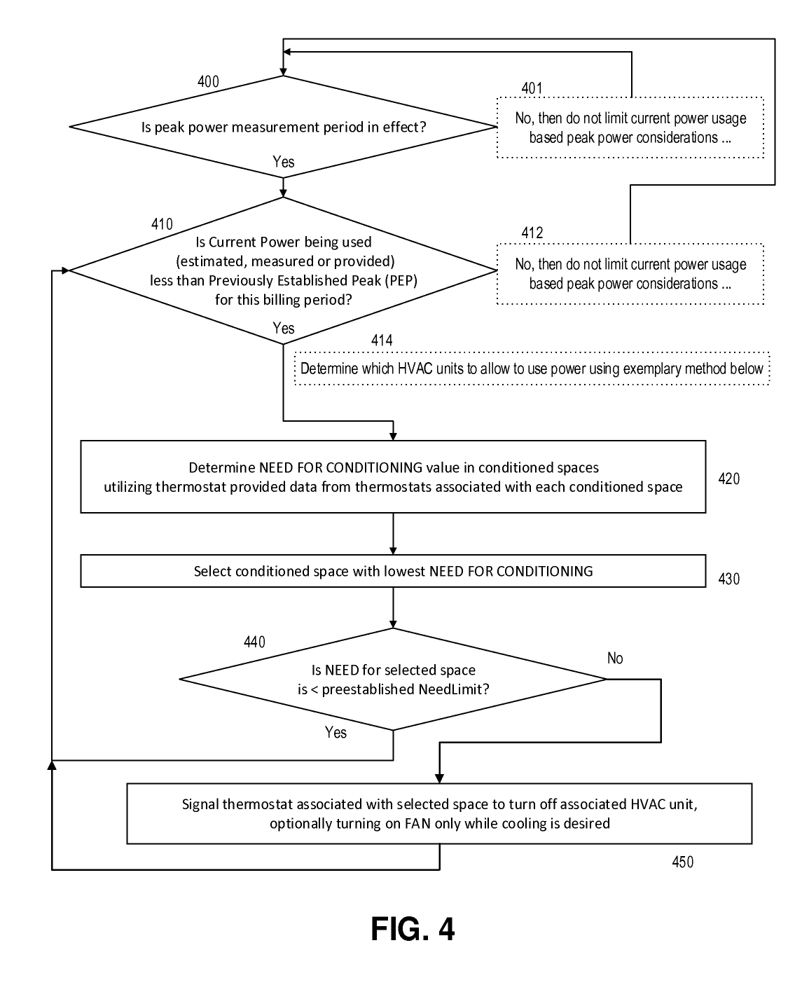

FIG. 4 illustrates a simple exemplary method for managing peak power usage for a facility including a plurality of thermostats and HVAC systems conditioning air for a plurality of conditioned spaces. The method is meant to be illustrative and does not illustrate all the features of the present invention, but does provide illustration of one fairly simple approach to managing power usage for a plurality of HVAC systems so as to reduce peak power demand usage charges. In FIG. 4 the first step 400 is to determine if at the current time peak power usage is being measured for billing purposes by the power company/power meter serving a facility. If at the current time a peak power measurement period is not in effect then the thermostats can control the HVAC systems with any limits due to peak power usage ignored 401.

In similar manner, if the current power requirements for running the HVAC systems are not greater than a previously established peak power usage during the current billing period 410 then there is no need to limit power usage based upon peak power considerations 412.

It is assumed for this step that an apparatus/methodology is in place for measuring or estimating and then storing the highest peak power usage already established during the current billing period.

Determining a level of “NEED” for conditioning of air in each conditioned space 420 is based, for example, on comparison of a specific conditioned space's current temperature against the related thermostat's current set-point temperature. An improved comparison might be to compare the space's current temperature against a previously established “reasonably comfortable” temperature such as 72 degrees Fahrenheit, or another temperature optionally set by the facility management. Alternatively, both of these comparisons and other data can be incorporated into establishment of a relative level of conditioning “need” for each conditioned space. Then, the thermostat with the lowest non-zero “need” is turned off 430, and this is repeated until enough HVAC units are limited in power usage to keep current power usage below the previously established peak power usage for the current billing period. The term “relative need” is meant to describe an evaluation of need for conditioning of air estimated by a thermostat in comparison to need for conditioning of air estimated by one or more other thermostats. The “need” for conditioning in one exemplary implementation would be a numerical value or level of a signal such that that numerical value or level can be compared against other thermostat's numerical values or levels and a priority as to which or how many associated HVAC systems should be turned on while still limiting current power usage to be below some previously established level of collective power usage.

It is a further necessary for an improvement in implementation of the present invention to provide apparatus and/or method that determines based upon “need” when the previous highest peak power usage must be overridden in order to provide for a reasonable level of comfort in the conditioned spaces. This is required in order to avoid conditioned turning off an HVAC system for so long that conditions in the space become “intolerable” (that is, for example, the difference in measured temperature and desired temperature is larger than some pre-established limit, such as for example, 5 degrees Fahrenheit. In this case it is necessary to provide for a decision that overrides the limit based on the previously established peak power usage. In FIG. 4, items 440 and 450 illustrate logic that checks whether a specific space has more “NEED” than what is allowed by some pre-established limit on need 440. The pre-established limit could be set by factory programming of the thermostat, or could be provided, for example, as input data by remote programming or by setting by facility personnel. If the NEED is less than the pre-established limit on need then the associated thermostat is signaled 450 to turn off its associated HVAC unit so as to limit overall peak power usage. If the NEED is greater than the pre-established limit on need then the thermostats are allowed to turn on or leave on their associated HVAC units, and this may result in going above the previously established peak power usage for the current billing period which will then establish a new previously established peak power usage for use from then on.

It is noted that in a preferred embodiment of the invention the monitoring and maintenance of a measure of peak power usage can and probably should be implemented as a separate apparatus or method. In a typical situation this is a preferred implementation because the period of time typically specified by a power company for measuring peak demand is a fairly long period of time such as, for example, fifteen minutes compared to the time between the turning on and off of a plurality of HVAC units, especially when a large number of HVAC units are in the facility. This also simplifies a typical implementation of such circuitry, apparatus, or method.

As previously mentioned, it is a further advantage in both implementation and performance if the actual measure of either or both of a) current demand related power usage, and b) previous peak demand power usage in the current billing cycle can be provided from a facility's power meter, or from the power company itself.

What is claimed is:

1) A thermostat for control of a Heating, Ventilation and/or Cooling system (HVAC system) which is part of a group of HVAC systems, the thermostat connectable to a local network connecting with one or more other thermostats, the thermostat and the one or more other thermostats forming a group of thermostats wherein each thermostat includes its own HVAC system control apparatus, the thermostat comprising:
A) a network connection apparatus connectable for communication with the one or more other thermostats of the group of thermostats, the communication with the one or more other thermostats including receiving therefrom, signal(s)/message(s) indicating a current operational status of the one or more other thermostats; and,
B) a peak power demand control apparatus for receiving the signals indicating the current operational status of the one or more other thermostats, the peak power demand control apparatus, in response to a current need for heating, ventilation and/or cooling and based upon the operational status signals received from the one or more other thermostats, being operative to either to turn on the HVAC system coupled thereto or to delay turning on the HVAC system so as to limit total current power demand of the group of HVAC systems.

2) The thermostat of claim 1 further comprising an occupancy sensing apparatus, the occupancy sensing apparatus operatively coupled to the peak power demand control apparatus for providing signals indicating a current condition of occupancy, the current condition of occupancy utilized by the peak power demand control apparatus in determining whether to turn on the HVAC system coupled thereto.

3) The thermostat of claim 2 further comprising occupancy pattern storage for storing patterns of occupancy, the patterns of occupancy utilized by the peak power demand control apparatus in determining whether to turn on the HVAC system coupled thereto or in the alternative to delay or inhibit turning on the HVAC system.

4) The thermostat of claim 1 wherein the peak power demand control apparatus further utilizes peak power demand rate characteristics of power supplied to the Heating Ventilation and/or Cooling systems in determining whether to turn on the HVAC system coupled thereto or to delay turning on the HVAC system.

5) The thermostat of claim 1 wherein the peak power demand control apparatus further includes a time of day clock for utilization in determining whether to turn on the HVAC system coupled thereto or to delay or inhibit turning on the HVAC system.

6) The thermostat of claim 1 wherein the peak power demand control apparatus further utilizes a peak power level previously established by the plurality of Heating Ventilation and/or Cooling systems in determining whether to turn on the HVAC system coupled thereto or to delay turning on the HVAC system.

7) An environmental control system connectable for controlling operation of a plurality of networked thermostats, each thermostat connectable to control one of a plurality of Heating Ventilation and/or Cooling systems and each thermostat including an occupancy sensor, the environmental control system comprising:
A) a message reception apparatus operatively coupled to the plurality of networked thermostats for receiving one or more operational status communications from each of the plurality of thermostats, the status communications including current need status information for heating ventilation and/or cooling, and current occupancy status information;
B) a message sending apparatus being operatively coupled for sending operational control communication commands to one or more of the plurality of networked thermostats; and,
C) a peak demand power limiting apparatus operatively coupled to the message reception apparatus and the message sending apparatus and in response to the operational status communications received from each of the plurality of thermostats including the current need status information and the current occupancy being operative based upon predetermined criteria to send power limiting operational control communication commands to one or more of the plurality of thermostats which limits overall peak power demand of the plurality of HVAC systems controlled by the plurality of networked thermostats.

8) The environmental control system of claim 7 wherein the power limiting operational control communication commands to one or more of the plurality of networked thermostats are further based upon peak power demand rate characteristics of power supplied to at least one of the Heating Ventilation and/or Cooling systems.

9) The environmental control system of claim 7 wherein the power limiting operational control communication commands to one or more of the plurality of networked thermostats are further based upon time of day.

10) The environmental control system of claim 7 wherein the power limiting operational control communication commands to one or more of the plurality of thermostats are further based upon an estimated peak power previously utilized by the plurality of Heating Ventilation and/or Cooling systems.

11) The environmental control system of claim 7 wherein the operational status communications include information to establish a relative level of need for conditioning of air in each of a plurality of conditioned spaces in which each of the plurality of networked thermostats is located.

12) A thermostat for control of an associated Heating, Ventilation and/or Cooling system (HVAC system) the associated HVAC system for conditioning of air in a conditioned space, the thermostat connectable to one or more other thermostats for controlling a directly related one or more other HVAC systems each conditioning air in an associated conditioned space, said thermostat and the one or more other thermostats forming a group of thermostats operatively coupled for controlling an overall group of associated HVAC systems, said thermostat comprising:
A) a network connection apparatus for forming an operable connection to the one or more other thermostats and receiving status data from the one or more other thermostats over that operable connection;
B) a temperature measurement apparatus for measuring a current conditioned space temperature;
C) temperature set-point storage for storing one or more temperature set points;
D) a peak power demand control apparatus utilizing the status data from the one or more other thermostats to limit power usage by its associated HVAC system so as to collectively limit peak power demand by the overall group of associated HVAC systems.

13) The thermostat of claim 12 where the operable connection to the one or more other thermostats is through a wireless mesh network where the thermostat is a node in the wireless mesh network.

14) The thermostat of claim 12 where the received status data is related to at least one of a) a current conditioned space temperature from the one or more other thermostats, b) a relative need for conditioning value from the one or more other thermostats, c) a difference between a conditioned space temperature measured by each of the one or more other thermostats and a pre-established setpoint temperature, d) a difference between a conditioned space temperature measured by each of the one or more other thermostats and a pre-established setpoint temperature stored in each one or more other thermostats.

15) An environmental control system controlling operation of a plurality of networked thermostats and an associated plurality of Heating Ventilation and Cooling Systems (HVAC Systems), each thermostat including an occupancy sensor, said environmental control system comprising:
A) a message reception apparatus operatively coupled to each of said plurality of networked thermostats for receiving one or more operational status communications from each of the plurality of networked thermostats, the operational status communications from each of the plurality of networked thermostats including for each: a) a current occupancy status, and, b) a current need for heating ventilation and/or cooling;
B) a message sending apparatus operatively coupled to each of said plurality of networked thermostats for sending operational control communication commands to the plurality of networked thermostats; and,
C) a peak demand power limiting apparatus operatively coupled to the message reception apparatus and the message sending apparatus and, in response to the operational status communications received from each of the plurality of thermostats, sending power limiting operational control communication commands to one or more of the plurality of thermostats and limiting overall peak power demand of said plurality of associated HVAC systems.

16) An environmental control system controlling operation of a plurality of networked thermostats and an associated plurality of Heating Ventilation and/or Cooling Systems (HVAC Systems) providing heating, ventilation and/or cooling to an associated conditioned space, said environmental control system comprising:
A) a message reception apparatus operatively coupled to each of said plurality of networked thermostats for receiving one or more operational status communications from each of the plurality of networked thermostats, the operational status communications from each of the plurality of networked thermostats including for each thermostat: a) current operational status of its associated HVAC system, and, b) need for heating ventilation and/or cooling in said thermostat's associated conditioned space;
B) a message sending apparatus operatively coupled to each of said plurality of networked thermostats for sending operational control communication commands to the plurality of networked thermostats; and,
C) a peak demand power limiting apparatus operatively coupled to the message reception apparatus and the message sending apparatus and, in response to the operational status communications received from each of the plurality of thermostats, sending power limiting operational control communication commands to one or more of the plurality of thermostats and limiting overall peak power demand of said plurality of associated HVAC systems.

17) A method of controlling power usage in conditioning of air in a plurality of conditioned spaces, the conditioning of air in a plurality of conditioned spaces provided by a related plurality of associated Heating, Ventilation and/or Cooling systems (HVAC systems), and measurement of conditioned space status in the plurality of conditioned spaces by a plurality of associated thermostats placed within the conditioned spaces, the method comprising the steps of:
A) accumulate the conditioned space status data from the plurality of thermostats and develop a level of need value for conditioning of air in each conditioned space;
B) determine a current total overall power usage estimate by the plurality of HVAC systems;
C) determine if current power usage needs to be limited based upon the current total overall power usage in comparison to a previously established peak power usage;
D) if current power usage needs to be limited select a conditioned space based upon the level of need values for conditioning of air in each conditioned space;
E) if the lowest level of need value for the selected conditioned space is greater than a preset level of need to provide reasonable comfort, then do not limit power usage by the related HVAC system providing conditioning of air to the selected conditioned space.
F) if the lowest level of need value for the conditioned space is less than the preset level of need to provide reasonable comfort, then limit power usage by the related HVAC system providing conditioning of air to the selected conditioned space

18) A thermostat for control of a Heating, Ventilation and/or Cooling system (HVAC system) which is part of a group of HVAC systems, the thermostat connectable to a local network connecting with one or more other thermostats, the thermostat and the one or more other thermostats forming a group of thermostats controlling a related group of HVAC systems wherein each thermostat includes its own HVAC system control apparatus, the thermostat comprising:
A) a network connection apparatus connectable for communication with the one or more other thermostats of the group of thermostats, the communication with the one or more other thermostats including receiving therefrom, signal(s)/message(s) indicating a current operational status of the one or more other thermostats; and,
B) a peak power demand control apparatus for receiving the signals indicating the current operational status of the one or more other thermostats, the peak power demand control apparatus, in response to a current need for heating, ventilation and/or cooling and based upon the operational status signals received from the one or more other thermostats, being operative to control the HVAC system coupled thereto so as to limit total current power demand of the group of HVAC systems.
